(19) United States
(12) Patent Application Publication
(10) Pub. No.: US 2026/0097412 A1
(43) Pub. Date: Apr. 9, 2026

(54) PRESSURE WASHER WITH ROLL CAGE

(71) Applicant: BLACK & DECKER INC., New Britain, CT (US)

(72) Inventors: Ryan WUERFL, Parkville, MD (US); Brian POOLE, Lutherville, MD (US); Anthony RETH, Baltimore, MD (US); Joshua SHEFFER, Dover, PA (US); Alexander NADER, Windsor Mill, MD (US); Samuel ESHELMAN, Fallston, MD (US); David WHEELER, Gananoque (CA); Josephine ARROWSMITH, Baltimore, MD (US)

(73) Assignee: BLACK & DECKER INC., New Britain, CT (US)

(21) Appl. No.: 19/416,738

(22) Filed: Dec. 11, 2025

Related U.S. Application Data
(63) Continuation of application No. 17/240,250, filed on Apr. 26, 2021, now Pat. No. 12,508,618.

(51) Int. Cl. B05B 15/14; B05B 9/01; B05B 9/08; B08B 3/02

(52) U.S. Cl. CPC B05B 15/14; B05B 9/01; B05B 9/0861; B08B 3/026; B08B 2203/0211

(57) ABSTRACT

A pressure washer unit includes a main housing containing components of the pressure washer and a roll cage surrounding the main housing for protection. The roll cage is generally rectangular and provides flat surfaces to make it easier to store the unit, and importantly provides a flat top surface to allow other items to stack on top of the unit. The main housing also includes a storage compartment to store accessories, including a trigger gun. The trigger gun includes a trigger guard with openings to store nozzles for the trigger gun.

### PRIORITY

This patent application is a Continuation of commonly assigned and co-pending U.S. patent application Ser. No. 17/240,250, filed on Apr. 26, 2021, the disclosure of which is hereby incorporated by reference in its entirety.

### FIELD OF THE INVENTION

This application is directed to a compact pressure washer with a roll cage frame for durability. The pressure washer also includes a trigger guard with storage for additional nozzles.

### BACKGROUND OF THE INVENTION

This section provides background information related to the present disclosure which is not necessarily prior art.

Traditional pressure washers are often bulky machines that come in uneven and irregular shapes. They typically store their accessories externally, making the unit even larger, bulkier, and more prone to unintentional damage to the accessories. Their shape and size make them difficult to store without taking up a large amount of space. Traditional pressure washers also do not provide a means for protection against harmful, extreme environments, or abusive transportation.

### BRIEF SUMMARY OF THE INVENTION

This section provides a general summary of the invention and is not a comprehensive disclosure of its full scope or all of its features.

In accordance with one aspect of the invention, the present invention has a main housing, surrounded by a protective roll cage. The roll cage is a multifunctional component of the pressure washer, not only preventing the unintentional damage to the main housing, but allowing for many of the features of the pressure washer to reside in a small, compact volume. The main housing holds all the operating components of the pressure washer, and further includes a storage compartment for accessories such as wands, a trigger gun, and nozzles.

The roll cage also supports the versatile storage of the pressure washer due to its flat rectangular shape. The unit can be stored horizontally or vertically, or stacked on top or beneath other products. This make storage of the unit simpler, especially when storing with other objects.

In another aspect of the invention, the pressure washer includes a trigger gun for directing the operation of the pressure washer. The trigger gun includes a trigger guard capable of storing different nozzles used with the trigger gun.

Further areas of applicability will become apparent from the description provided herein. The description and specific examples in this application are intended for purposes of illustration only and are not intended to limit the scope of the present disclosure.

### BRIEF DESCRIPTION OF THE INVENTION

Further features and advantages of the present invention will be better understood by reference to the following description, which is given by way of example and in association with the accompanying drawings, in which:

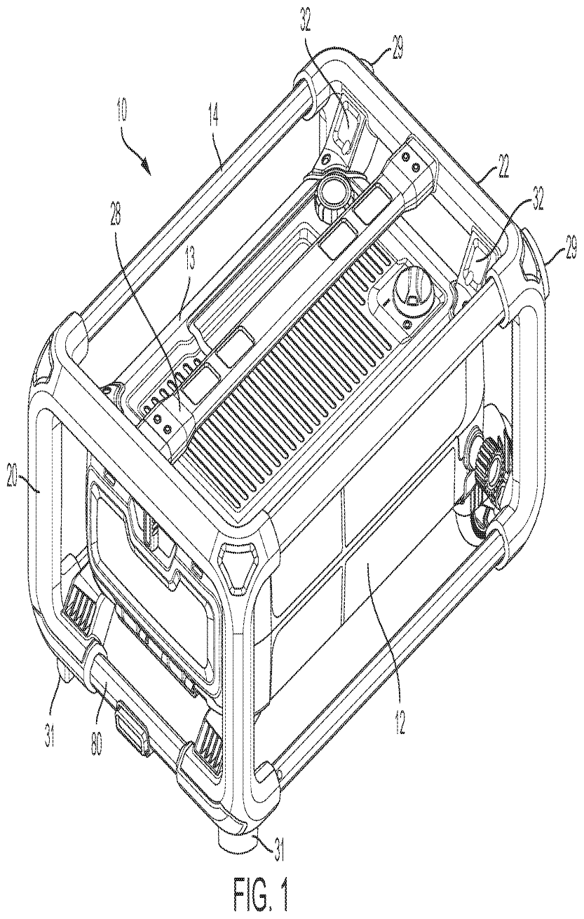

FIG. 1 is a front perspective view of a pressure washer of the present invention;

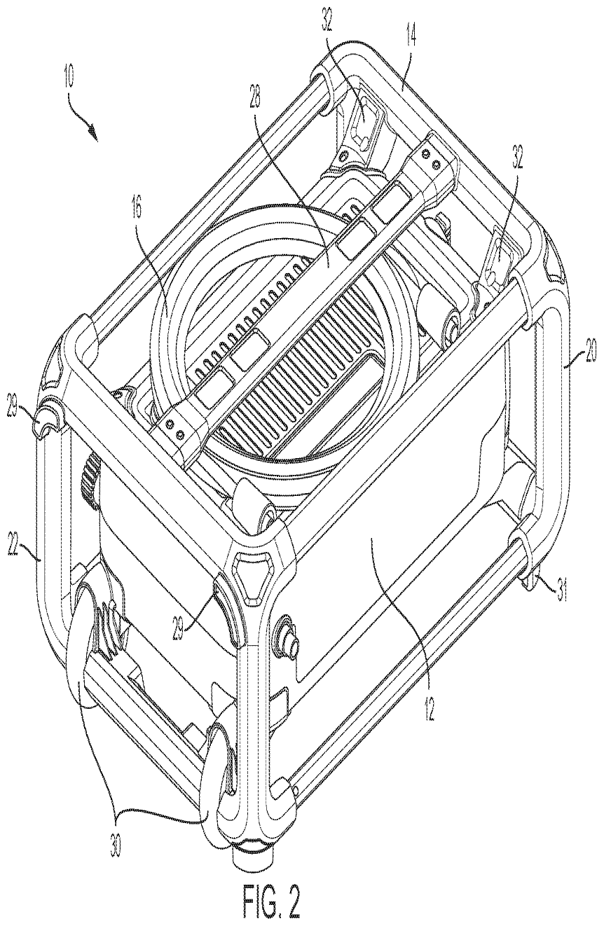

FIG. 2 is a rear perspective view of the pressure washer of FIG. 1;

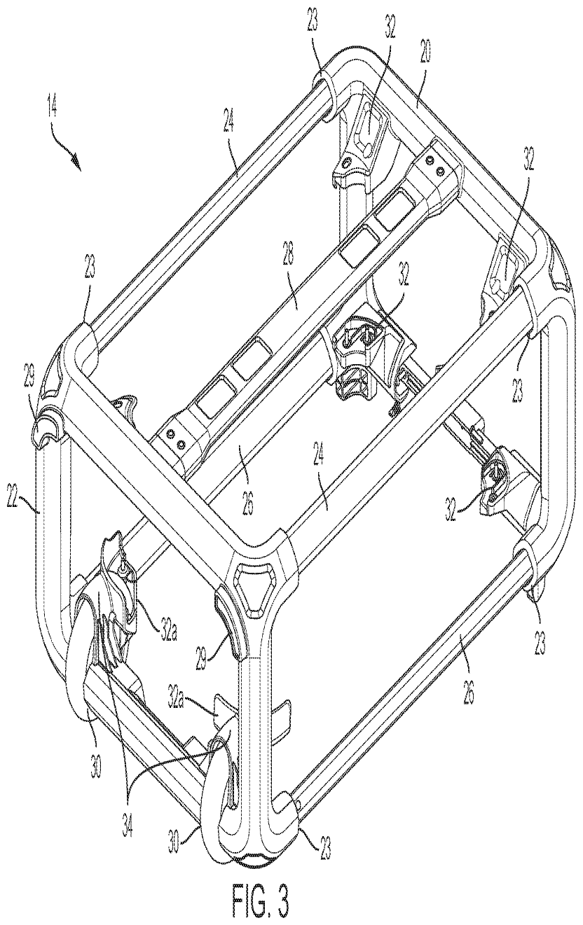

FIG. 3 is the roll cage of FIG. 2;

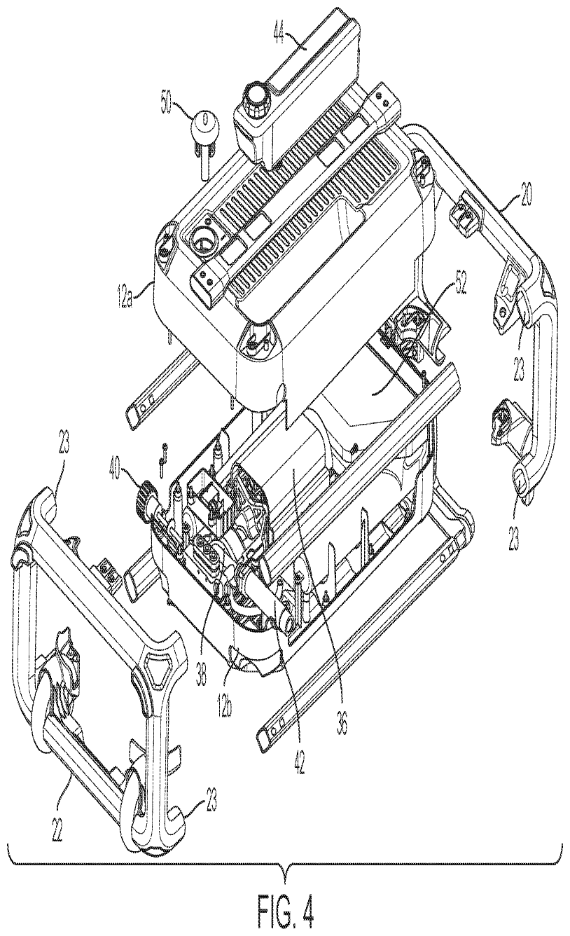

FIG. 4 is an exploded view of the pressure washer;

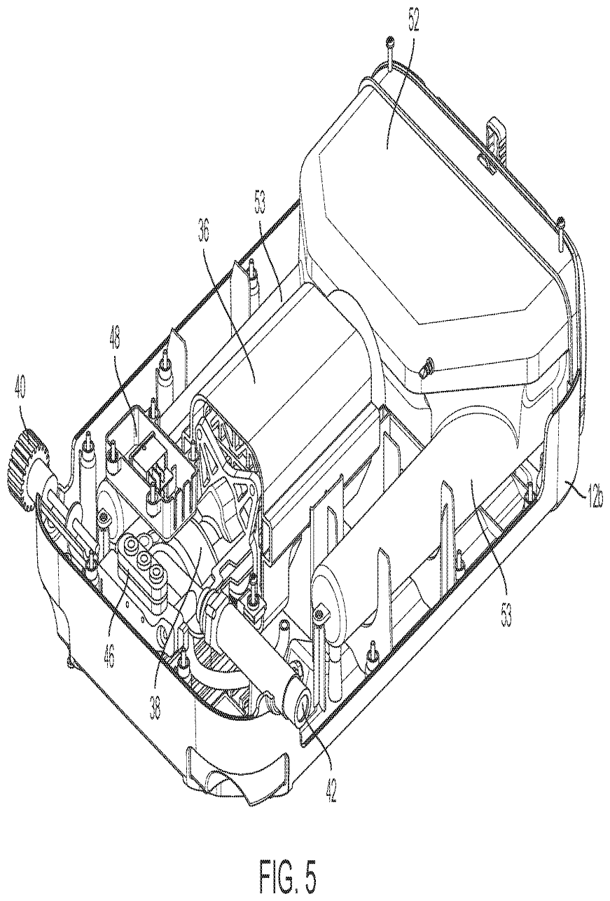

FIG. 5 is an interior view of the main housing;

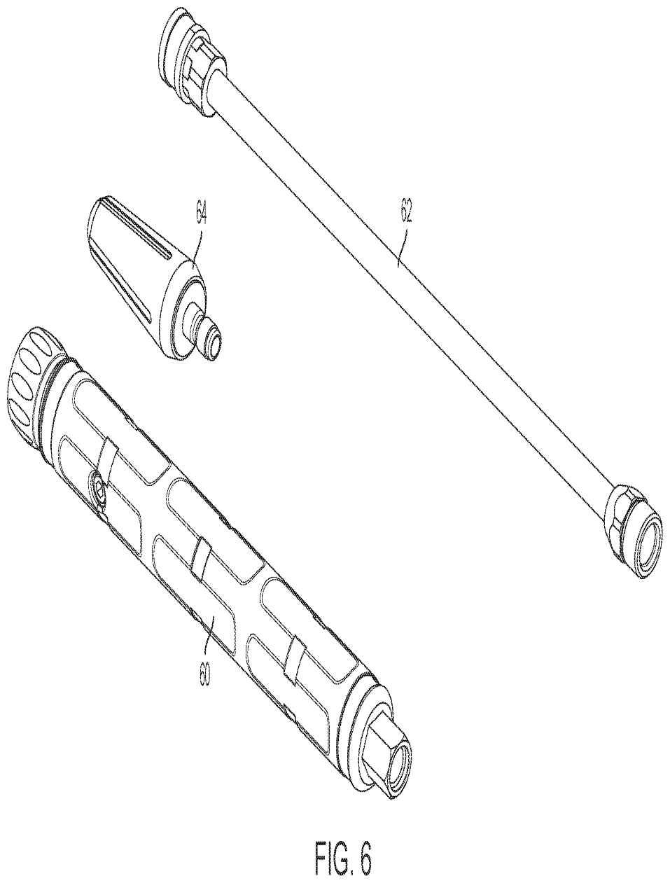

FIG. 6 shows the accessories for the pressure washer;

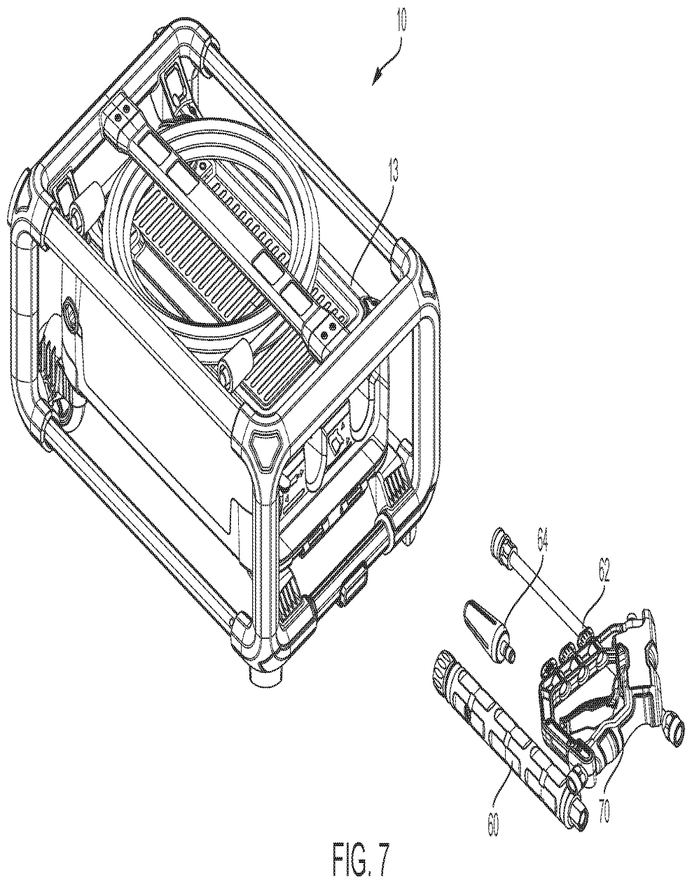

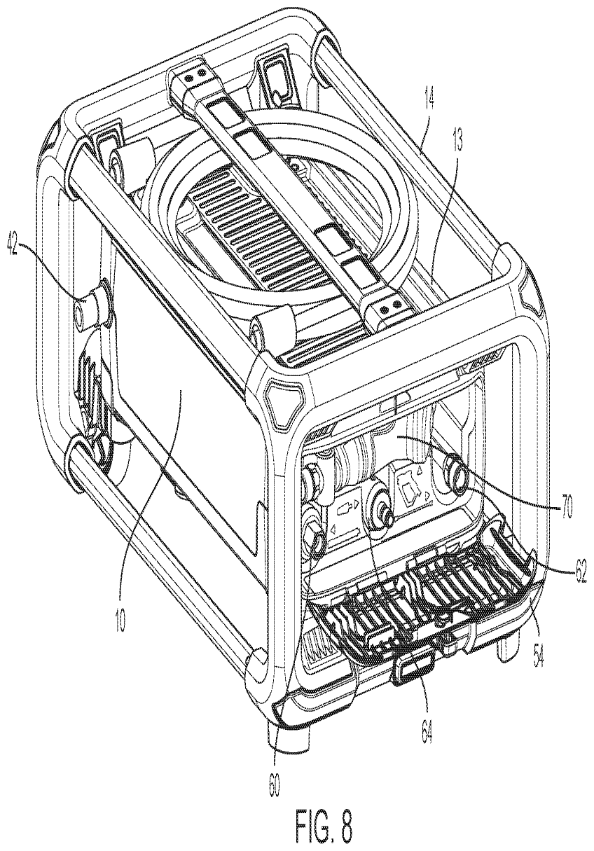

FIGS. 7 and 8 show the accessories before and after storage in the main housing;

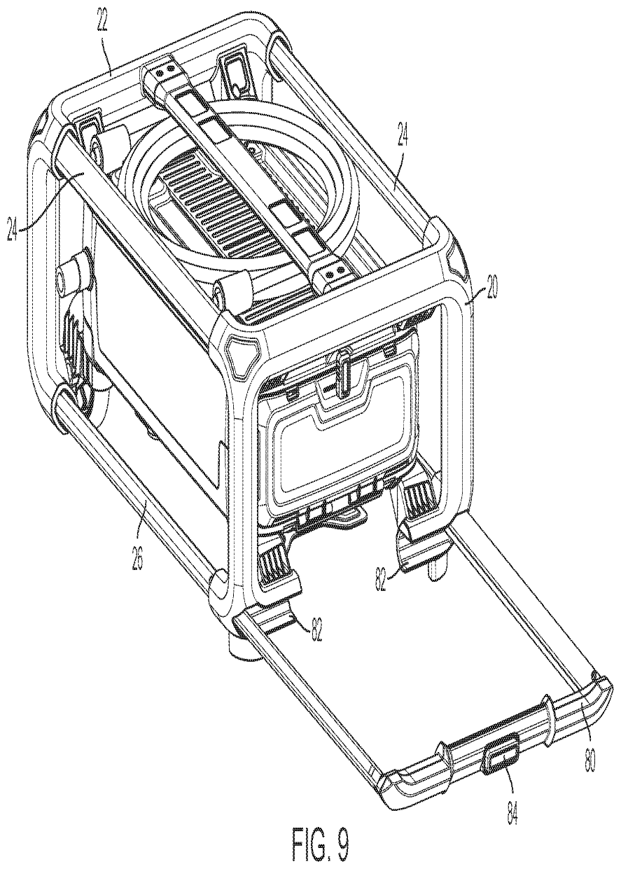

FIG. 9 shows the telescoping handle is an extended position;

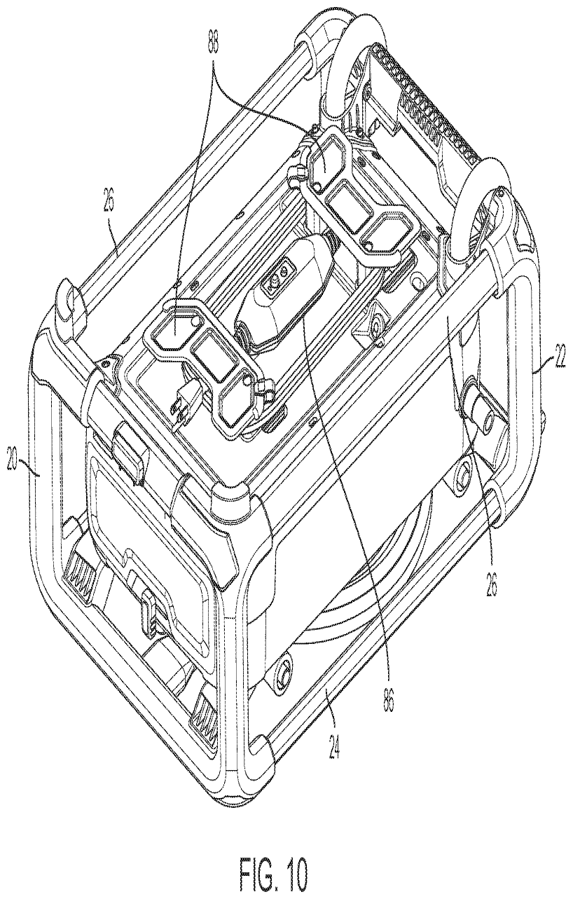

FIG. 10 is a bottom view of the pressure washer;

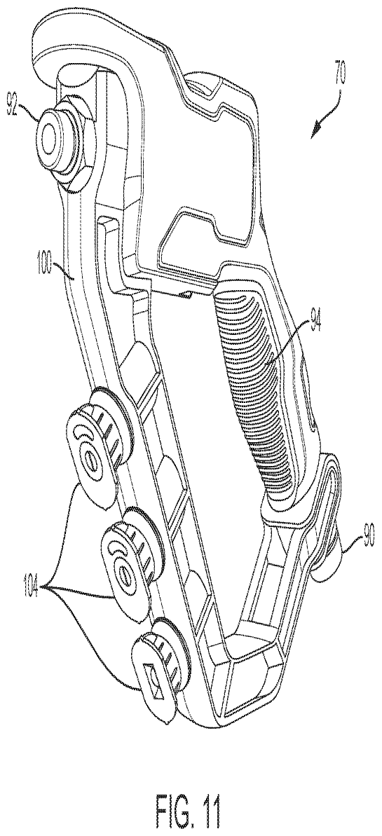

FIGS. 11-13 show the trigger gun for use with the pressure washer; and

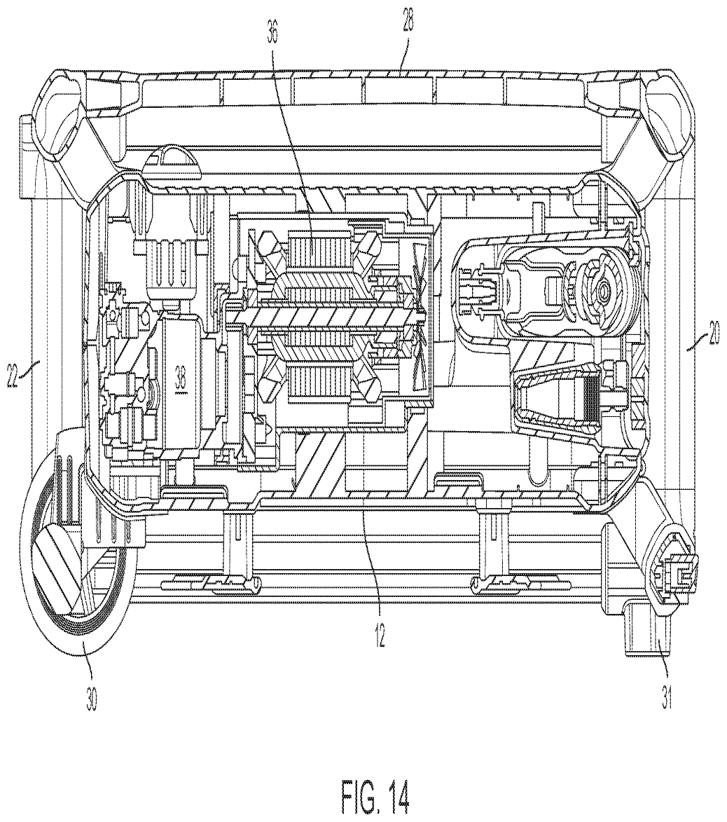

FIG. 14 shows a side sectional view of the pressure washer.

### DETAILED DESCRIPTION OF THE INVENTION

The present invention is directed to a compact pressure washer that's durable and easy to store. With reference to FIGS. 1 and 2, the pressure washer 10 includes a main housing 12 surrounded by a generally rectangular shaped roll cage 14. FIG. 1 shows a top front view while FIG. 2 is a top rear view.

FIG. 3 shows the roll cage 14 without the main housing 12 for clarity. The roll cage 14 has a front end face 20 and a rear end face 22 connected by two top bars 24 and two bottom bars 26. The corners of the end faces 20 and 22 include openings 23 into which the bars 24 and 26 are inserted to form the roll cage. An additional handle bar 28 extends the length of the roll cage, and in addition to providing greater rigidity, acts as a convenient handle for lifting or otherwise grabbing the pressure washer. Furthermore, the bars 24 and 26, and the cross bars of the end faces 20 and 22 provide additional gripping surfaces, providing the user with multiple grab points that allow the pressure washer to be easily handled and transported.

Referring to FIGS. 2 and 14, the space between the handle bar 28 the housing 12 is sized to securely hold a hose 16 in place. The spacing is determined to frictionally hold the hose 16 while also being flush with the top surface of the roll cage 14, as best shown in FIG. 14. In the present invention, the dimension from the housing 12 to the handle bar 28 is 38.7 mm, but it should be understood that this dimension is dependent upon multiple factors, including the hose diameter, handle thickness, etc. and the important feature is that the hose 16 be secured in place by the handle bar 28, while be flush with the top surface of the roll cage.

Also, as shown in FIGS. 1, 2 and 8, the outer perimeter of the top of the housing 12 has a heightened wall 13 that creates a well or concavity at the center of the housing. When the hose 16 is then placed under the handle bar 28, it is forced into the well by the handle bar 28 so that is sits securely in the well. The top bars 24 of the roll cage further help to secure the hose 16 in place.

Importantly, all this is done while maintaining the uniform shape of the roll cage/pressure washer by keeping the handle bar 28 flush with the other frame members of the roll cage 14. This allows other objects to be stacked on top (or sides) of the roll cage for easy storage.

Referring again to FIGS. 1-3, the roll cage 14 is secured to the main housing 12 through brackets 32 at the corners of both end faces 20 and 22. The rear end face 22 includes a pair of wheels 30 that allow the pressure washer to be rolled across a surface, and the bottom brackets 32a on the rear end face 22 are formed on wheel covers 34. Opposite the wheels 30 on the front end face 20 are a pair of feet 31 that support the roll cage 14 in its horizontal position. A pair of additional feet 29 are on the rear end face 22 opposite the wheels to support the roll cage in a vertical position.

Referring now to FIGS. 4 and 5, the main housing 12 will be described. The main housing 12 is formed from two clamshell housing halves 12a and 12b, which hold the working components of the pressure washer, including a motor 36 and pump 38. A water inlet 40 is located at one side of the housing for connection to garden hose or other water source, and a water outlet 42 is located on an opposite side for connection to the high pressure hose 16, which connects to a trigger gun 70.

A soap dispenser 44 is stored within the top housing 12a. The soap dispenser holds cleaning solution and provides it to a manifold 46 which mixes the solution with the water flow before exiting through the outlet 42.

A switch assembly 48 is located adjacent the motor 36 and pump 38. The switch assembly 48 is preferably a rocker switch, but can be any type of on/off switch. A knob 50 is positioned on the top housing 12a and its underside includes a rib which contacts the switch assembly 48. As a user rotates the knob 50 between the on and off position, the switch assembly 48 is switched between its on and off position.

As can best be seen in FIG. 5, most of the operating components are located in a rear portion of the housing 12, with a storage bin 52 placed in a front portion. The storage bin 52 holds various accessories for the pressure washer, including different types of wands and nozzles. For example, FIG. 6 shows a gripping wand 60, a standard wand 62, a turbo nozzle 64 and the trigger gun 70, all of which can be stored within the storage bin 52 as shown in FIGS. 7 and 8. FIG. 8 shows a door 54 that closes the storage bin 52 to retain and protect the accessories therein. It should be noted that the door 54 has been removed from the other figures solely for clarity, and the present invention is intended to incorporate the door 54. Furthermore, the storage bin is shaped to accommodate the accessories, as shown for example, in FIG. 5. Therefore, the storage bin 52 includes arms 53 on both sides of the motor that are capable of holding the wands 60 and 62.

Referring to FIG. 9, the roll cage 14 also includes a telescoping handle 80 that forms the bottom cross bar on the front end face 20. The end face 20 includes open channels 82 that hold the handle 80 when retracted, and a button 84 to lock and release the handle 80.

It is important to note that the main housing 12 and all the other associated components of the pressure washer including the soap dispenser 44, water inlet 40, water outlet 42 and accessories are all contained within the roll cage frame 14. This reduces the likelihood of damage to the unit, especially from drops and other accidents.

The pressure washer of the present invention is an AC unit with a power cord 86 as shown in FIG. 10. The cord is wrapped around posts 88 for easy storage. Although the pressure washer is shown as an AC unit, the features described in the present invention could be applied to a battery powered electric unit, a gas unit, or any other power source.

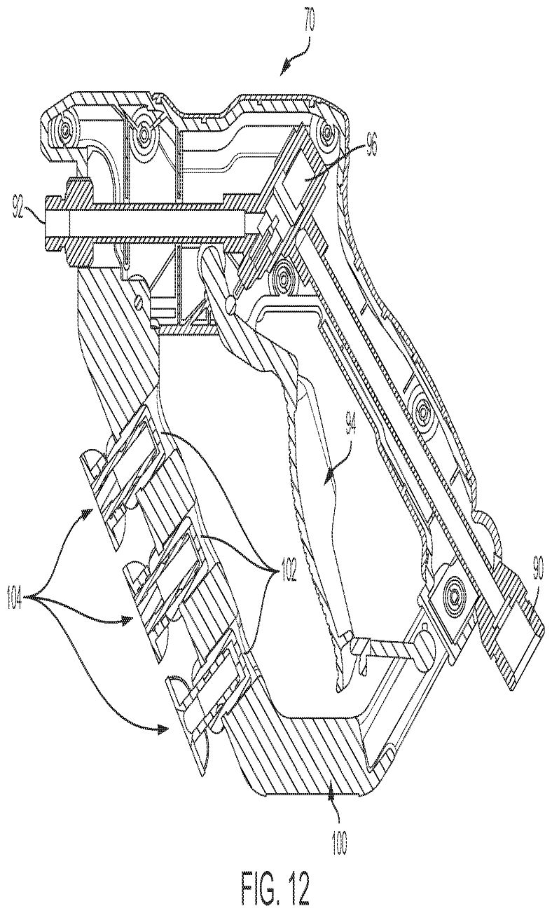

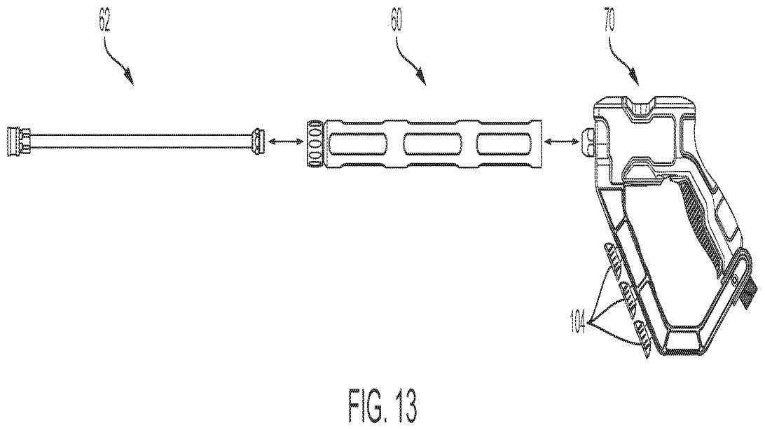

Referring now to FIGS. 11 and 12, which show the trigger gun 70. The gun includes a trigger 94 (in FIG. 11, the trigger is shown in the retracted position) and a water inlet 90 that's connected to the outlet 42 of the pressure washer by the hose 16. An outlet 92 of the gun is connected to accessories, such as those stored in the storage bin 52. FIG. 13 shows an example of how the wands are connected to the trigger gun 70, with gripping wand 60 and standard wand 62 attached to the trigger gun 70. Various nozzles can be attached at the end of the wand 62 for different spray profiles as desired. The trigger 94 is connected to a valve 96 to control the actuation of the water flow, however different valve designs can be incorporated to control water flow rate and/or water pressure if needed.

A trigger guard 100 is placed surrounding the trigger 94 to protect it from damage and reduce the chances of accidental actuation. The guard 100 includes several openings 102 for holding additional nozzles for the pressure washer. The openings 102 include grommets which frictionally hold the nozzles 104. Pressure washers typically come with multiple nozzle having different performance profiles which are selected depending on the job being performed. Traditional pressure washers typically store these extra nozzles on the main body of the unit, making it inconvenient for the user to switch nozzles. Locating the extra nozzles on the trigger gun itself, allows for a quick and easy means for storing and accessing different nozzles when needed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A pressure washer unit comprising:
a main housing comprising:
a motor,
a pump, and
a storage compartment to store accessories, the accessories including one or more of a trigger gun, a wand, and nozzles;
a hose; and
a roll cage having a cuboid shape, wherein the roll cage comprises a front end face and a rear end face connected by two top bars and two bottom bars, and
wherein the main housing and the hose are contained within a perimeter of the roll cage.

2. The pressure washer unit of claim 1, wherein the storage compartment includes a door that closes to retain and protect the accessories stored inside the storage compartment.

3. The pressure washer unit of claim 1, wherein the storage compartment includes at least one extended compartment that extends along a side of the motor in the main housing.

4. The pressure washer unit of claim 3, wherein the at least one extended compartment has an elongated shape to store the wand.

5. The pressure washer unit of claim 1, wherein the roll cage further comprises:
an extendable handle to be inserted inside the two bottom bars,
wherein, when the extendable handle is retracted into the two bottom bars, a cross bar of the extendable handle forms a bottom edge of the front end face, and when the extendable handle is extended from the two bottom bars, the cross bar of the extendable handle becomes an extended handle for pulling the pressure washer unit.

6. The pressure washer unit of claim 1, wherein the roll cage further comprises:
a handle bar that extends from the front end face to the rear end face and is parallel with the two top bars,
wherein the hose is to be stored in a space between the handle bar and a top surface of the main housing and secured in place by the handle bar.

7. The pressure washer unit of claim 6, wherein an outer perimeter of the top surface of the main housing has a heightened wall that creates a well at a center of the top surface of the main housing for storing the hose.

8. The pressure washer unit of claim 1, further comprising:
a power cord, wherein the power cord is to be stored in a space between the two bottom bars and a bottom surface of the main housing.

9. The pressure washer unit of claim 1, wherein the motor and the pump are located in one portion of the main housing, and the storage compartment is located in another portion of the main housing.

10. The pressure washer unit of claim 1, wherein the roll cage further includes brackets extending from four corners of the front end face and four corners of the rear end face to the main housing to secure the main housing to the roll cage.

11. A pressure washer unit comprising:
a main housing comprising:
a motor,
a pump, and
a storage bin to store accessories,
a hose; and
a roll cage having a cuboid-shaped frame that surrounds the main housing and the hose, wherein the roll cage includes:
a front end face and a rear end face connected by two top bars and two bottom bars, and
a handle bar that extends from the front end face to the rear end face and is parallel with the two top bars,
wherein the hose is to be placed in a space between the handle bar and a top surface of the main housing.

12. The pressure washer unit of claim 11, wherein the accessories to be stored in the storage bin include a trigger gun, a wand, and nozzles.

13. The pressure washer unit of claim 12, wherein the storage bin includes at least one extended compartment that extends along a side of the motor in the main housing.

14. The pressure washer unit of claim 13, wherein the at least one extended compartment has an elongated shape to store the wand.

15. The pressure washer unit of claim 11, wherein the storage bin includes a door that closes to retain and protect the accessories stored inside the storage bin.

16. The pressure washer unit of claim 11, wherein the roll cage further includes:
an extendable handle to be inserted inside the two bottom bars,
wherein, when the extendable handle is retracted into the two bottom bars, a cross bar of the extendable handle forms a bottom edge of the front end face, and when the extendable handle is extended from the two bottom bars, the cross bar of the extendable handle becomes an extended handle for pulling the pressure washer unit.

17. The pressure washer unit of claim 11, wherein the space between the handle bar and the top surface of the main housing is sized to have a specific dimension for storing the hose within the roll cage and securing the hose in place by the handle bar.

18. The pressure washer unit of claim 17, wherein an outer perimeter of the top surface of the main housing has a heightened wall that creates a well at a center of the top surface of the main housing for storing the hose.

19. The pressure washer unit of claim 11, further comprising:
a power cord, wherein the power cord is to be stored in a space between the two bottom bars and a bottom surface of the main housing.

20. The pressure washer unit of claim 19, wherein the roll cage further comprises two posts located in the space between the two bottom bars and the bottom surface of the main housing, and wherein the power cord is to be wrapped around the two posts for storage.
